(19) United States
(12) Patent Application Publication
(10) Pub. No.: US 2020/0044462 A1
(43) Pub. Date: Feb. 6, 2020

(54) CHARGE SYSTEM, BATTERY PACK, AND PROTECTION APPARATUS

(71) Applicant: Envision AESC Energy Devices Ltd., Sagamihara-shi, Kanagawa (JP)

(72) Inventor: Hiroshi SASAKI, Sagamihara-shi (JP)

(73) Assignee: Envision AESC Energy Devices Ltd., Sagamihara-shi, Kanagawa (JP)

(21) Appl. No.: 16/485,053

(22) PCT Filed: Feb. 14, 2018
(86) PCT No.: PCT/JP2018/004985

§ 371 Date: Aug. 19, 2019

(30) Foreign Application Priority Data
Feb. 22, 2017 (JP) 2017-030990

(51) Int. Cl. H02J 7/00; H01M 10/46; H01M 10/48; H01M 10/42

(52) U.S. Cl. CPC H02J 7/0026; H02J 7/0014; H01M 10/46; H01M 2010/4278; H01M 10/425; H01M 2010/4271; H01M 10/48

(57) ABSTRACT

A battery pack includes a battery cell, a measurement device that measures a physical quantity relevant to the battery pack, an input terminal to which a charging current is supplied from a protection apparatus, a state information generation unit that generates state information showing the measured physical quantity, and a communication terminal through which the state information is output. The protection apparatus includes an output terminal connected to the input terminal that supplies the charging current to the battery pack, a communication terminal to which the state information is input, an input terminal to which the charging current is supplied, an interconnect connected between the input and output terminals, a switch provided on the interconnect, and a control unit that opens and closes the switch based on the physical quantity shown in the state information. The battery pack and the protection apparatus are provided in different housings.

### TECHNICAL FIELD

The present invention relates to secondary battery charging.

### BACKGROUND ART

There is a storage battery which is formed by connecting a plurality of secondary batteries in series. Hereinafter, the secondary battery is referred to as a battery cell. Generally, the storage battery is operated while being stored in the same housing together with a mechanism (Battery Management System (BMS)), which is used to manage the storage battery, or the like. A set of the storage battery stored in the housing and the mechanism used to manage the storage battery is referred to as a battery pack.

In relation to charging of a storage battery, a technology for controlling such the charging is developed. Patent Document 1 discloses a technology for controlling the charging by taking a voltage balance of each battery cell into consideration for a battery pack which includes a plurality of battery cells. In the battery pack, a bypass circuit is provided on an interconnect through which a current used to charge each battery cell flows. Furthermore, in the battery pack, a detection circuit which is used to detect the voltage of each battery cell is provided. In addition, a microcomputer is stored in the same housing together with a charger. The microcomputer acquires the voltage of each battery cell, which is detected in the detection circuit, and controls the bypass circuit based on the voltage. A switch is provided in the bypass circuit, and it is possible to switch between a state in which the charging current flows to the battery cell and a state in which the charging current flows through the bypass circuit (a state in which the charging current does not flow to the battery cell) by opening and closing the switch.

Patent Document 2 discloses an overcharge protection apparatus which is used to prevent a battery from being excessively charged. The overcharge protection apparatus is interposed between a charger and a battery which is charged by the charger. Furthermore, the overcharge protection apparatus includes a voltage measurement device. In a case where the battery is charged by connecting the overcharge protection apparatus to the charger and the battery, a voltage of the battery is measured by the voltage measurement device. Furthermore, in a case where the voltage of the battery is higher than a pre-determined voltage, the overcharge protection apparatus controls a switch provided in the overcharge protection apparatus so that the charging current is not supplied from the charger to the battery.

### RELATED DOCUMENT

### Patent Document

[Patent Document 1] Japanese Patent Application Publication No. H9-306550

[Patent Document 2] Japanese Patent Application Publication No. 2007-295728

### SUMMARY OF THE INVENTION

### Technical Problem

The storage battery could be required to be lightweight according to its usage. For example, in a case where a storage battery is mounted on a small moving body (particularly, a flying object), the storage battery is required to be lightweight. An objective of the present invention is to provide a new technology to reduce the weight of the storage battery.

### Solution to Problem

A charging system according to the present invention includes a battery pack and a protection apparatus.

The battery pack includes 1) a battery cell, 2) a measurement device that measures a physical quantity relevant to the battery pack, 3) an input terminal to which a charging current is supplied from the protection apparatus, 4) a state information generation unit that generates state information which indicates the measured physical quantity, and, 5) a communication terminal through which the state information is output to the protection apparatus.

The protection apparatus includes 1) an output terminal that is connected to the input terminal of the battery pack, and supplies the charging current from a power supply to the battery pack, 2) a communication terminal to which the state information, which is output from the battery pack, is input, 3) an input terminal to which the charging current is supplied from the power supply, 4) an interconnect that connects between the input terminal and the output terminal of the protection apparatus, 5) a switch that is provided on the interconnect, and 6) a control unit that performs opening and closing of the switch based on the measured physical quantity indicated by the state information.

The battery pack and the protection apparatus are provided in housings which are different from each other.

A battery pack according to the present invention includes 1) a battery cell, 2) a measurement device that measures a physical quantity which indicates a battery pack state, 3) an input terminal to which a charging current is supplied from a protection apparatus which controls charging of the battery pack, 4) a state information generation unit that generates state information which indicates the measured physical quantity, 5) a communication terminal through which the state information is output to the protection apparatus, and 6) an interconnect that connects the input terminal and the battery cell.

The charging current, which is supplied to the input terminal, is supplied to the battery cell through the interconnect. A switch that blocks connection between the input terminal and the battery cell is not provided over the interconnect.

### Advantageous Effects of Invention

According to the present invention, a new technology which performs weight reduction of a storage battery is provided.

### BRIEF DESCRIPTION OF THE DRAWINGS

The above-described object, other objects, features, and advantages will be further apparent with preferable example embodiments, which will be described below, and the accompanying drawings below.

FIG. 1 is a diagram illustrating a basic functional configuration of a charging system.

FIG. 2 is a diagram illustrating a computer which is used to realize a control unit.

FIG. 3 is a block diagram illustrating a charging system according to a first example embodiment.

FIG. 4 is a diagram illustrating the charging system in a case where a protection apparatus recognizes a battery pack.

FIG. 5 is a diagram illustrating an output device which is included in the protection apparatus.

FIG. 6 is a block diagram illustrating a charging system according to a second example embodiment.

FIG. 7 is a flowchart illustrating a flow of a process which is performed in the charging system.

FIG. 8 is a block diagram illustrating a charging system according to a third example embodiment.

### DESCRIPTION OF EMBODIMENTS

Hereinafter, example embodiments of the present invention will be described with reference to the accompanying drawings. Also, the same symbols are attached to the same components and the description thereof will not be repeated throughout the drawings. In addition, unless description is particularly performed, each block in a block diagram indicates a configuration in a functional unit instead of a configuration in a hardware unit.

### Basic Configuration

<Outline of Functional Configuration>

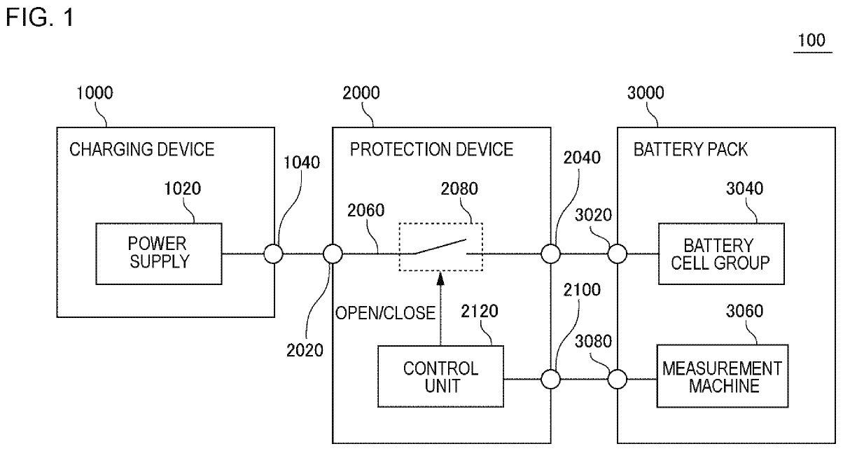

First, a basic configuration common to respective example embodiments of a charging system according to the present invention will be described. FIG. 1 is a diagram illustrating an example of a basic functional configuration of a charging system 100. The charging system 100 includes a charging apparatus 1000, a protection apparatus 2000, and a battery pack 3000. In the charging system 100, at least, a housing for realizing the protection apparatus 2000 and a housing for realizing the battery pack 3000 are different from each other. In addition, a housing for realizing the charging system 100 is also different from the housing for realizing the battery pack 3000. The charging apparatus 1000 and the protection apparatus 2000 may be realized in the same housing or may be realized in housings which are different from each other.

The charging apparatus 1000 is an apparatus which is used to supply a charging current to the battery pack 3000 to be charged. The charging current is supplied from a power supply 1020. Note that, the power supply 1020 may be provided inside the charging apparatus 1000 or may be provided outside the charging apparatus 1000. In a latter case, the charging apparatus 1000 draws the current from the power supply 1020 (for example, a system power supply) which is provided outside the charging apparatus 1000, and supplies the current to the battery pack 3000.

The battery pack 3000 is a battery pack in which one or more secondary battery unit cells (hereinafter, battery cells) are stored. The battery pack 3000 includes a first input terminal 3020, a battery cell group 3040, a measurement device 3060, and a first communication terminal 3080. The first input terminal 3020 is a terminal to which the charging current is input. The battery cell group 3040 includes one or more battery cells 3042 (not illustrated in the drawing). The battery cell 3042 is a unit cell of an arbitrary secondary battery (for example, a lithium ion battery). The battery cell group 3040 is charged using the charging current which is input from the first input terminal 3020. The measurement device 3060 is a measurement device 3060 which is used to recognize a state of the battery pack 3000. The first communication terminal 3080 is a terminal which is used to output information indicating a result of measurement by the measurement device 3060 to the protection apparatus 2000.

The protection apparatus 2000 is an apparatus which is interposed between the charging apparatus 1000 and the battery pack 3000, and which controls supply of the charging current from the charging apparatus 1000 to the battery pack 3000. The protection apparatus 2000 includes an input terminal 2020, a first output terminal 2040, and an interconnect 2060. The input terminal 2020 is a terminal to which the charging current supplied from the charging apparatus 1000 is input. The first output terminal 2040 is a terminal which is used to output the charging current to the battery pack 3000. The interconnect 2060 is an interconnect which connects the input terminal 2020 with the first output terminal 2040. The charging current supplied from the charging apparatus 1000 to the protection apparatus 2000 flows over the interconnect 2060 and is output to the battery pack 3000.

The protection apparatus 2000 controls the supply of the charging current from the charging apparatus 1000 to the battery pack 3000 based on the state of the battery pack 3000 which is recognized using the measurement device 3060. To do so, the protection apparatus 2000 further includes a switch 2080, a first communication terminal 2100, and a control unit 2120.

The switch 2080 is a switch which is provided on the interconnect 2060. For example, the switch 2080 is realized using a Field Effect Transistor (FET). The control of the switch 2080 enables to switch between a state in which the input terminal 2020 and the first output terminal 2040 are connected to each other and a state in which the input terminal 2020 and the first output terminal 2040 are not connected to each other. In the state where the input terminal 2020 and the first output terminal 2040 are connected to each other, the charging current flows through the interconnect 2060, and thus it is possible to supply the charging current from the charging apparatus 1000 to the battery pack 3000. On the other hand, in the state where the input terminal 2020 and the first output terminal 2040 are not connected to each other, the charging current does not flow through the interconnect 2060, and thus it is not possible to supply the charging current from the charging apparatus 1000 to the battery pack 3000.

Here, control which causes the state in which the input terminal 2020 and the first output terminal 2040 are connected to each other (control which causes the charging current to flow over the interconnect 2060) is referred to as “close the switch 2080”. On the other hand, control which causes the state in which the input terminal 2020 and the first output terminal 2040 are not connected to each other (control which causes the charging current to not flow over the interconnect 2060) is referred to as “open the switch 2080”.

The control unit 2120 performs opening and closing of the switch 2080 based on the result of the measurement by the measurement device 3060. The information, which indicates the result of the measurement by the measurement device 3060, is input from the battery pack 3000 to the protection apparatus 2000 through the first communication terminal 2100.

In the present invention, with the above-described configuration, it is possible to control charging of the battery pack 3000 by taking the state of the battery pack 3000 into consideration. Accordingly, it is possible to avoid occurrence of a problem due to charging of the battery pack 3000 when the state of the battery pack 3000 is not suitable for charging.

<Outline of Hardware Configuration>

The control unit 2120 may be realized by hardware (for example: a hard-wired electronic circuit or the like) or may be realized by a combination (for example: a combination of an electronic circuit and a program which controls the electronic circuit, or the like) of hardware and software. Hereinafter, a case where the control unit 2120 is realized by the combination of the hardware and the software will be further described.

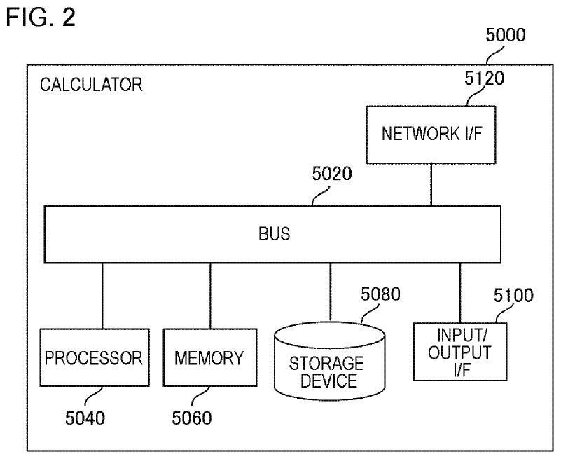

FIG. 2 is a diagram illustrating a computer 5000 which is used to realize the control unit 2120. For example, the computer 5000 is an integrated circuit such as a System on Chip (SoC). The computer 5000 may be a dedicated computer designed to realize the control unit 2120, or may be a general-purposed computer.

The computer 5000 includes a bus 5020, a processor 5040, a memory 5060, a storage device 5080, an input/output interface 5100, and a network interface 5120. The bus 5020 is a data transmission path which is used such that the processor 5040, the memory 5060, the storage device 5080, the input/output interface 5100, and the network interface 5120 transmit and receive data to and from each other. However, a method for connecting the processor 5040 and the like to each other is not limited to bus connection. The processor 5040 is a processor such as a Central Processing Unit (CPU) or a Graphics Processing Unit (GPU). The memory 5060 is a memory such as a Random Access Memory (RAM) or a Read Only Memory (ROM). The storage device 5080 is a storage device such as a hard disk, a Solid State Drive (SSD), or a memory card. In addition, the storage device 5080 may be a memory such as the RAM or the ROM.

The input/output interface 5100 is an interface which is used to connect the computer 5000 to another device. The network interface 5120 is an interface which is used to communicably connect the computer 5000 to an external apparatus.

The storage device 5080 stores a program module which is used to realize a function of the control unit 2120. The processor 5040 realizes the function of the control unit 2120 by reading and executing the program module in the memory 5060.

A hardware configuration of the computer 5000 is not limited to the configuration illustrated in FIG. 2. For example, the respective program modules may be stored in the memory 5060. In this case, the computer 5000 may not include the storage device 5080.

Hereinafter, detailed example embodiments of the above-described charging system 100 will be described.

### First Example Embodiment

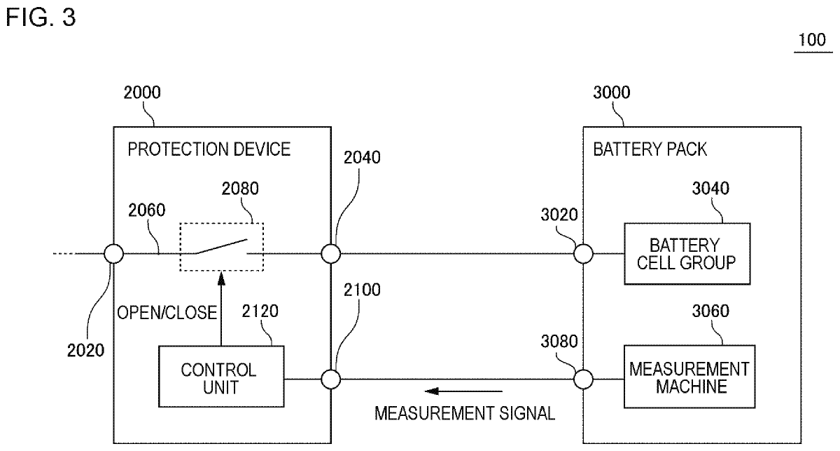

FIG. 3 is a block diagram illustrating a charging system 100 according to a first example embodiment. In FIG. 3, the charging apparatus 1000 is not illustrated. In the example embodiment, a measurement signal, which indicates the result of the measurement by the measurement device 3060, is supplied from the battery pack 3000 to the protection apparatus 2000. The measurement signal is an electric signal which indicates a physical quantity relevant to the battery pack 3000. The physical quantity relevant to the battery pack 3000 is a physical quantity which indicates, for example, the state of the battery pack 3000 such as a voltage of the battery cell group 3040, a current which flows through battery cell group 3040, or a temperature in a housing of the battery pack 3000.

For example, the measurement signal is a signal which is output from a measurement device (a voltage measurement device, a current measurement device, a temperature sensor, or the like) used to measure the physical quantity relevant to the battery pack 3000, or a signal which is acquired by amplifying the signal using an amplifier or the like. The physical quantity relevant to the battery pack 3000 is indicated using, for example, a value which is acquired from an amplitude of the measurement signal (a peak value or an average value of an amplitude). For example, the physical quantity relevant to the battery pack 3000 is acquired by multiplying the peak value of the amplitude of the measurement signal by a pre-determined value. That is, in this case, the physical quantity relevant to the battery pack 3000 is a value which is proportional to the peak value of the amplitude of the measurement signal.

The control unit 2120 performs the opening and closing of the switch 2080 based on the measurement signal. Hereinafter, a state of the battery pack 3000, which is taken into consideration by the control unit 2120 in order to perform the opening and closing of the switch 2080, will be described in detail.

<Overvoltage>

In a case where the battery cell group 3040 is in an overvoltage state (in a state where it is excessively charged), the control unit 2120 controls the switch 2080 such that the charging current is not supplied to the battery cell group 3040. Specifically, the control unit 2120 determines whether or not the voltage of the battery cell group 3040 indicates the overvoltage state. Furthermore, in a case where the voltage of the battery cell group 3040 indicates the overvoltage state, the control unit 2120 opens the switch 2080.

In this case, the measurement device 3060 is the voltage measurement device which measures the voltage of the battery cell group 3040. Furthermore, for example, the measurement signal is an electric signal which indicates the voltage of the battery cell group 3040 by a magnitude of the amplitude.

There are various detailed methods for controlling the switch 2080 according to whether or not the voltage of the battery cell group 3040 indicates the overvoltage state. For example, the control unit 2120 converts the measurement signal received in the first communication terminal 2100 into the voltage of the battery cell group 3040. Furthermore, in a case where the voltage of the battery cell group 3040 is equal to or higher than a threshold, the control unit 2120 opens the switch 2080. The threshold is stored, for example, in the storage device 5080 in advance (it is the same as various thresholds which are used by the control unit 2120 and which will be described later).

A conversion rule with which the measurement signal is converted into the voltage of the battery cell group 3040 is defined in advance. For example, the conversion rule is a rule which is used to associate a statistic value (a peak value, an average value, or the like) acquired from the amplitude of the measurement signal with the voltage of the battery cell group 3040. The conversion rule is stored, for example, in the storage device 5080. The control unit 2120 converts the measurement signal into the voltage of the battery cell group 3040 using the conversion rule.

A method for controlling the switch 2080 by the control unit 2120 is not limited to the above-described conversion method. For example, in a case where the statistic value acquired from the amplitude of the measurement signal is equal to or larger than the threshold, the control unit 2120 opens the switch 2080.

Note that, the control unit 2120 may determine whether or not each of the battery cells 3042 included in the battery cell group 3040 is in the overvoltage state instead of whether or not the battery cell group 3040 is in the overvoltage state. For example, in a case where at least one battery cell 3042 is in the overvoltage state, the control unit 2120 opens the switch 2080. A method for determining whether or not each of the battery cells 3042 is in an over discharge state is the same as the method for determining whether or not the battery cell group 3040 is in the over discharge state.

In a case where the determination is performed on each battery cell 3042, the measurement device 3060 measures a voltage of each battery cell 3042. Furthermore, the measurement signal which indicates the voltage of each battery cell 3042 is transmitted from the measurement device 3060 to the protection apparatus 2000.

When there are a plurality of measurement signals to be supplied to the protection apparatus 2000, the plurality of measurement signals may be respectively transmitted through different signal lines or the plurality of measurement signals may be transmitted through one signal line. In a former case, a plurality of sets of the communication terminals (the first communication terminal 2100 of the protection apparatus 2000 and the first communication terminal 3080 of the battery pack 3000) are provided, and the plurality of sets of the communication terminals are respectively connected through the signal lines. On the other hand, in a case where the plurality of measurement signals are transmitted through one signal line, for example, the control unit 2120 distinguishes among the respective measurement signals using a time division multiplex method or the like.

<Deep Discharge>

In a case where the battery cell group 3040 is in a deep discharge state, the control unit 2120 controls the switch 2080 such that the charging current is not supplied to the battery cell group 3040. Specifically, the control unit 2120 determines whether or not the voltage of the battery cell group 3040 indicates the deep discharge state. Furthermore, in a case where the voltage of the battery cell group 3040 indicates the deep discharge state, the control unit 2120 opens the switch 2080.

In this case, the measurement device 3060 is the voltage measurement device which measures the voltage of the battery cell group 3040. In another example, the measurement signal is the electric signal which indicates the voltage of the battery cell group 3040 by a magnitude of the amplitude.

There are various detailed methods for controlling the switch 2080 according to whether or not the voltage of the battery cell group 3040 indicates the deep discharge state. For example, the control unit 2120 converts the measurement signal received in the first communication terminal 2100 into the voltage of the battery cell group 3040 using the above-described conversion rule. Furthermore, the control unit 2120 determines whether or not the voltage of the battery cell group 3040 is equal to or lower than the threshold, and opens the switch 2080 in a case where the voltage of the battery cell group 3040 is equal to or lower than the threshold. On the other hand, in a case where the voltage of the battery cell group 3040 is not equal to or lower than the threshold, the control unit 2120 closes the switch 2080.

The method for controlling the switch 2080 by the control unit 2120 is not limited to the above-described conversion method. For example, the control unit 2120 determines whether or not the statistic value acquired from the amplitude of the measurement signal is equal to or less than the threshold. In a case where the statistic value is equal to or less than the threshold, the control unit 2120 opens the switch 2080. On the other hand, in a case where the statistic value is not equal to or less than the threshold, the control unit 2120 closes the switch 2080.

Note that, the control unit 2120 may determine whether or not each of the battery cells 3042 included in the battery cell group 3040 is in the deep discharge state instead of whether or not the battery cell group 3040 is in the deep discharge state. For example, in a case where at least one battery cell 3042 is in the deep discharge state, the control unit 2120 opens the switch 2080. A method for determining whether or not each of the battery cells 3042 is in the deep discharge state is the same as a method for determining whether or not the battery cell group 3040 is in the deep discharge state.

<Overcurrent>

In a case where the battery cell group 3040 is in an overcurrent state (a state in which a current that flows into the battery cell group 3040 is excessively large), the control unit 2120 opens the switch 2080 such that supply of the current to the battery cell group 3040 is stopped. Specifically, the control unit 2120 determines whether or not the current that flows into the battery cell group 3040 indicates overcurrent. Furthermore, in a case where the current that flows into the battery cell group 3040 indicates overcurrent, the control unit 2120 opens the switch 2080.

In this case, the measurement device 3060 is a current measurement device which measures the current that flows into the battery cell group 3040. Furthermore, for example, the measurement signal is an electric signal which indicates a magnitude of the current that flows into the battery cell group 3040 by a magnitude of the amplitude.

There are various detailed methods for controlling the switch 2080 according to whether or not the current of the battery cell group 3040 is in the overcurrent state. For example, the control unit 2120 converts the measurement signal received in the first communication terminal 2100 into the current that flows into the battery cell group 3040. Furthermore, in a case where the current that flows into the battery cell group 3040 is equal to or larger than the threshold, the control unit 2120 opens the switch 2080. On the other hand, in a case where the current that flows into the battery cell group 3040 is not equal to or larger than the threshold, the control unit 2120 opens the switch 2080.

A conversion rule, which is used to convert the measurement signal into the current that flows into the battery cell group 3040, is defined in advance. For example, the conversion rule is a rule which is used to associate the statistic value acquired from the amplitude of the measurement signal with the current that flows into the battery cell group 3040. The conversion rule is stored, for example, in the storage device 5080. The control unit 2120 converts the measurement signal into the current that flows into the battery cell group 3040 using the conversion rule.

The method for controlling the switch 2080 by the control unit 2120 is not limited to the above-described conversion method. For example, in a case where the statistic value acquired from the amplitude of the measurement signal is equal to or larger than the threshold, the control unit 2120 opens the switch 2080. On the other hand, in a case where the statistic value acquired from the amplitude of the measurement signal is not equal to or larger than the threshold, the control unit 2120 closes the switch 2080.

Note that, the control unit 2120 may determine whether or not each of the battery cells 3042 included in the battery cell group 3040 is in the overvoltage state instead of whether or not the battery cell group 3040 is in the overvoltage state. For example, in a case where at least one battery cell 3042 is in the overvoltage state, the control unit 2120 opens the switch 2080. A method for determining whether or not each of the battery cells 3042 is in the over discharge state is the same as the method for determining whether or not the battery cell group 3040 is in the over discharge state.

In a case where the determination is performed on each of the battery cells 3042, the measurement device 3060 measures the voltage of each battery cell 3042. Furthermore, the measurement signal which indicates the voltage of each battery cell 3042 is transmitted from the measurement device 3060 to the protection apparatus 2000.

<Temperature Abnormality>

In a case where temperature abnormality occurs in the battery pack 3000 (in a case where a temperature in the housing of the battery pack 3000 is excessively high), the control unit 2120 opens the switch 2080 such that the current is not supplied to the battery cell group 3040. Specifically, the control unit 2120 determines whether or not a temperature of the battery pack 3000 indicates a temperature abnormality state. Furthermore, in a case where the temperature of the battery pack 3000 indicates a state of the temperature abnormality, the control unit 2120 opens the switch 2080.

In this case, the measurement device 3060 is a temperature sensor which measures the temperature in the housing of the battery pack 3000. It is preferable that the temperature sensor is provided to measure a temperature of the battery cell group 3040 or a temperature in the vicinity of the battery cell group 3040. For example, the measurement signal is an electric signal which indicates the temperature of the battery pack 3000 by a magnitude of the amplitude.

There are various detailed methods for controlling the switch 2080 according to whether or not the temperature of the battery pack 3000 indicates the state of the temperature abnormality. For example, the control unit 2120 converts the measurement signal which is received in the first communication terminal 2100 into the temperature of the battery pack 3000. Furthermore, in a case where the temperature of the battery pack 3000 is equal to or higher than the threshold, the control unit 2120 opens the switch 2080. On the other hand, in a case where the temperature of the battery pack 3000 is not equal to or higher than the threshold, the control unit 2120 closes the switch 2080.

A conversion rule, which is used to convert the measurement signal into the temperature of the battery pack 3000, is defined in advance. For example, the conversion rule is a rule which is used to associate the statistic value acquired from the amplitude of the measurement signal with the temperature of the battery pack 3000. The conversion rule is stored, for example, in the storage device 5080. The control unit 2120 converts the measurement signal into the temperature of the battery pack 3000 using the conversion rule.

The method for controlling the switch 2080 by the control unit 2120 is not limited to the above-described conversion method. For example, in a case where the statistic value acquired from the amplitude of the measurement signal is equal to or larger than the threshold, the control unit 2120 opens the switch 2080. On the other hand, in a case where the statistic value acquired from the amplitude of the measurement signal is not equal to or larger than the threshold, the control unit 2120 closes the switch 2080.

<Cell Balance Abnormality>

In a case where cell balance abnormality occurs in the battery cell group 3040, the control unit 2120 opens the switch 2080 such that the current is not supplied to the battery cell group 3040. Here, the cell balance abnormality means that voltages largely vary among the plurality of battery cells 3042 which are included in the battery cell group 3040. The control unit 2120 determines whether or not the voltages of the plurality of battery cells 3042 which are included in the battery cell group 3040 indicate a state of the cell balance abnormality. Furthermore, in a case where the voltages of the battery cells 3042 indicate the state of the cell balance abnormality, the control unit 2120 opens the switch 2080.

The measurement device 3060 is a voltage measurement device which measures the voltage of each battery cell 3042. For example, the measurement signal is an electric signal which indicates the voltage of the battery cell 3042 by a magnitude of the amplitude.

There are various detailed methods for controlling the switch 2080 according to whether or not the voltage of the battery cell 3042 indicates the state of the cell balance abnormality. For example, the control unit 2120 converts each measurement signal indicating the voltage of the battery cell 3042 into the voltage of the battery cell 3042. Furthermore, the control unit 2120 calculates an index value which indicates a variation on the voltage of the battery cell 3042. In a case where the index value is equal to or larger than the threshold, the control unit 2120 opens the switch 2080. On the other hand, in a case where the index value is not equal to or larger than the threshold, the control unit 2120 closes the switch 2080. The index value indicating the variation on the voltage of the battery cell 3042 is, for example, a dispersion or a standard deviation of the voltage of the battery cell 3042.

In another example, the control unit 2120 may calculate the index value of the variation on the voltage of the battery cell 3042 from the statistic value acquired from each measurement signal which indicates the voltage of the battery cell 3042. Furthermore, in a case where the index value is equal to or larger than the threshold, the control unit 2120 opens the switch 2080. In a case where the index value is not equal to or larger than the threshold, the control unit 2120 closes the switch 2080.

<Case in which Plurality of States are Considered>

The control unit 2120 controls the switch 2080 based on any one or more of the above-described various states (the overvoltage, the deep discharge, and the like) of the battery pack 3000. In a case where the control unit 2120 controls the switch 2080 by taking the plurality of states of the battery pack 3000 into consideration, the control unit 2120 opens the switch 2080 when, for example, determining “open the switch 2080” in at least one of the above-described respective determinations relevant to the states of the battery pack 3000. On the other hand, the control unit 2120 closes the switch 2080 when determining “close the switch 2080” in all the above-described respective determinations relevant to the states of the battery pack 3000.

<Method for Identifying Battery Pack 3000>

Correspondence between the measurement signal provided from the battery pack 3000 and the physical quantity relevant to the battery pack 3000 that is indicated by the measurement signal may differ according to a type of the battery pack 3000. In this case, the conversion rule, which is used to convert the measurement signal into the physical quantity relevant to the battery pack 3000, differs for each type of the battery pack 3000. In addition, the threshold to be compared with the physical quantity relevant to the battery pack 3000 or with the statistic value acquired from the measurement signal may differ for each type of the battery pack 3000. For example, what degree of the voltage of the battery cell group 3040 causes the overvoltage or deep discharge state differs according to the battery pack 3000. In this case, the threshold used for the above-described various determinations differs according to the type of the battery pack 3000.

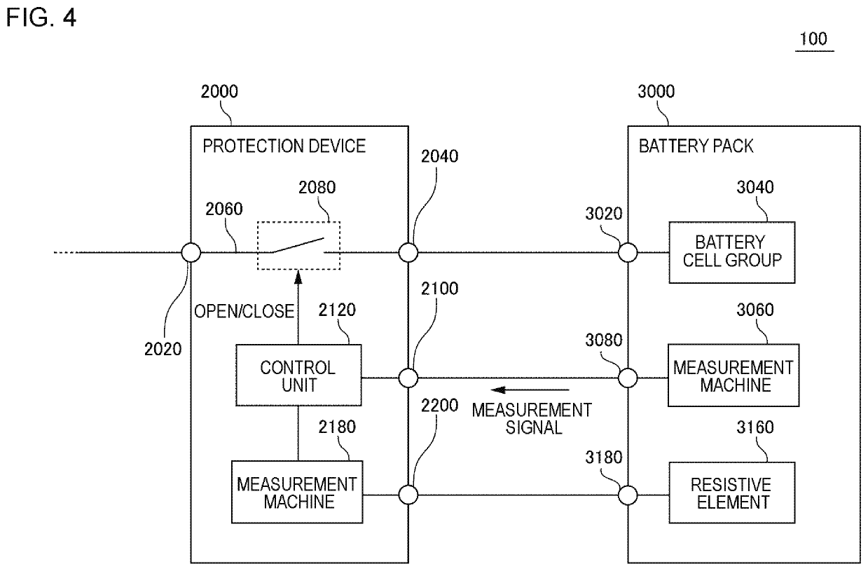

Here, it is preferable that the protection apparatus 2000 identifies the type of the battery pack 3000 and performs control according to the identified type of the battery pack 3000. FIG. 4 is a diagram illustrating the charging system 100 in a case where the protection apparatus 2000 identifies the battery pack 3000. In FIG. 4, the charging apparatus 1000 is not illustrated. The protection apparatus 2000 of FIG. 4 further includes a measurement device 2180 and a second output terminal 2200. In addition, the battery pack 3000 further includes a resistive element 3160 and a second input terminal 3180. The measurement device 2180 and the resistive element 3160 are connected through the second output terminal 2200 and the second input terminal 3180.

The resistive element 3160 is an arbitrary resistive element provided in the battery pack 3000 such that a resistance value differs for each type of the battery pack 3000. The measurement device 2180 applies a pre-determined voltage to the resistive element 3160. In this manner, the current flows over the interconnect which connects the measurement device 2180 and the second output terminal 2200. Furthermore, the measurement device 2180 measures the current.

Here, since the resistance value of the resistive element 3160 differs according to the type of the battery pack 3000, the current measured by the measurement device 2180 also differs according to the type of the battery pack 3000. From this fact, it is possible to determine the type of the battery pack 3000 using the current measured by the measurement device 2180.

Here, the control unit 2120 controls the switch 2080 based on the current measured by the measurement device 2180. For example, the control unit 2120 converts the statistic value acquired from the measurement signal into a physical quantity of the battery pack 3000 using the pre-determined conversion rule. In this case, the conversion rule is defined for each type of the battery pack 3000. The control unit 2120 determines the type of the battery pack 3000 according to the current measured by the measurement device 2180, and acquires the conversion rule corresponding to the determined type of the battery pack 3000. Furthermore, the control unit 2120 converts the statistic value acquired from the measurement signal into the physical quantity of the battery pack 3000 using the acquired conversion rule.

In another example, the control unit 2120 controls the switch 2080 by comparing the statistic value acquired from the measurement signal with the threshold. In this case, the threshold is defined for each type of the battery pack 3000. The control unit 2120 determines the type of the battery pack 3000 according to the current measured by the measurement device 2180, and acquires the threshold corresponding to the determined type of the battery pack 3000. Furthermore, the control unit 2120 controls the switch 2080 by comparing the statistic value acquired from the measurement signal with the acquired threshold.

<Notification of State of Battery Pack 3000>

In a case where the control unit 2120 performs control to open the switch 2080 according to the state of the battery pack 3000, the charging current is not supplied to the battery pack 3000. That is, the battery pack 3000 is not charged. In this case, it is preferable to enable a user of the charging system 100 to recognize a fact that the battery pack 3000 is not charged and a cause thereof.

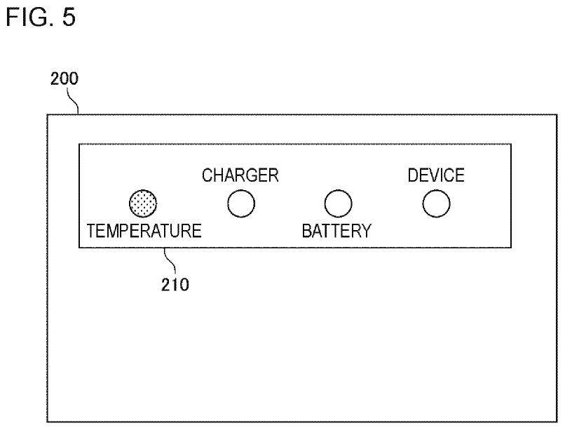

Here, the protection apparatus 2000 may include an output device which provides a notification with respect to the user. For example, the output device is an apparatus which provides the notification using a Light Emitting Diode (LED) lamp FIG. 5 is a diagram illustrating an output device included in the protection apparatus 2000. A housing 200 is a housing of the protection apparatus 2000. A display device 210 is the above-described display device.

The display device 210 includes a plurality of LED lamps The control unit 2120 provides a notification that the battery pack 3000 is not charged and the cause thereof to the user, by turning on the LED lamps that corresponds to the cause of the open of the switch 2080. A case where no LED lamp is turned on indicates a fact that the battery pack 3000 is charged. However, it is possible to separately provide an LED lamp to be used to indicate the fact that the battery pack 3000 is charged.

A case where an LED lamp having a label “temperature” is turned on is a case to open the switch 2080 because of the temperature abnormality of the battery pack 3000.

A case where an LED lamp having a label “charger” is turned on is a case to open the switch 2080 because of the charging apparatus 1000. For example, a case where the battery cell group 3040 is in the overvoltage state corresponds to the above case.

A case where an LED lamp having a label “battery” is turned on is a case to open the switch 2080 because there is a problem in the battery pack 3000 (excluding the temperature abnormality). For example, the case includes the case where the battery cell group 3040 is in the deep discharge state and the case where the cell balance abnormality occurs in the battery cell group 3040.

A case where an LED lamp having a label “device” is turned on is a case to open the switch 2080 because there is a problem in the protection apparatus 2000 or the battery pack 3000. For example, in a case where the abnormality exists in various types of hardware which are provided in the protection apparatus 2000 (the computer 5000 which realizes the switch 2080 and the control unit 2120), the protection apparatus 2000 turns on this LED lamp In another example, in a case where it is not possible to receive the measurement signal from the battery pack 3000, the protection apparatus 2000 turns on this LED lamp

In a case where the display device 210 is included in the protection apparatus 2000 as described above, convenience of the charging system 100 (convenience of the protection apparatus 2000) is improved for the user of the charging system 100.

Note that, a method for providing the notification to the user is not limited to the method using the LED lamp For example, the notification may be provided to the user in such a way that a display device is provided in the protection apparatus 2000 and the display device displays a message or the like. In addition, the notification may be provided to the user in such a way that a speaker is provided in the protection apparatus 2000 and the speaker outputs a voice message or the like.

<Advantageous Effect>

There is a case where the battery pack 3000 is required to be miniaturized and reduced in weight. An example is a case where the battery pack 3000 is mounted on a flying object such as a drone. At this point, in a case where a charging control mechanism is provided in the battery pack 3000, miniaturization and weight reduction of the battery pack 3000 is difficult.

According to the charging system 100 of the example embodiment, a mechanism (hereinafter, the charging control mechanism) for controlling whether or not to charge the battery pack 3000 is realized in a housing which is different from either the charging apparatus 1000 or the battery pack 3000. Accordingly, it facilitates miniaturization and weight reduction of the battery pack 3000, compared to the case where the charging control mechanism is provided in the battery pack 3000.

In addition, in the charging system 100 of the example embodiment, the measurement signal which indicates a result of the measurement in the measurement device 3060 is provided to the protection apparatus 2000, and control using the measurement signal is performed on the protection apparatus 2000. Accordingly, it is not necessary to provide the mechanism which processes the result of the measurement of the measurement device 3060 in the battery pack 3000. Specifically, a mechanism (control unit 2120), which analyzes the state of the battery pack 3000 indicated by the result of the measurement of the measurement device 3060, is provided in the protection apparatus 2000, and thus it is not necessary to provide such a mechanism in the battery pack 3000. Therefore, the battery pack 3000 can be further miniaturized and reduced in weight.

### Second Example Embodiment

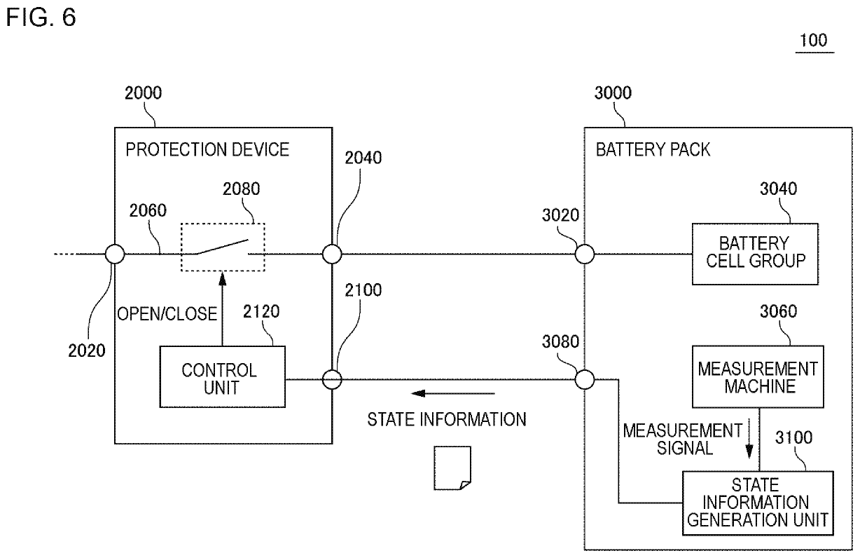

FIG. 6 is a block diagram illustrating a charging system 100 according to a second example embodiment. In FIG. 6, the charging apparatus 1000 is not illustrated. In the example embodiment, the battery pack 3000 includes a state information generation unit 3100. The state information generation unit 3100 generates digital data which indicates the result of the measurement by the measurement device 3060. Hereinafter, the digital data is referred to as state information. Furthermore, the state information generation unit 3100 provides the state information to the control unit 2120 through the first communication terminal 3080.

As described in the first example embodiment, the measurement device 3060 outputs the measurement signal which indicates the result of the measurement. The measurement signal indicates the physical quantity relevant to the battery pack 3000. The state information generation unit 3100 generates the state information which indicates the physical quantity, by converting the measurement signal into the physical quantity indicated by the measurement signal.

The control unit 2120 acquires the state information through the first communication terminal 2100. Furthermore, the control unit 2120 controls the switch 2080 based on the physical quantity relevant to the battery pack 3000 that is indicated by the state information.

<Method for Generating State Information>

As described above, the state information generation unit 3100 generates the state information which indicates the physical quantity relevant to the battery pack 3000, from the measurement signal output from the measurement device 3060. A detailed method thereof is the same as a method for converting the measurement signal into the physical quantity relevant to the battery pack 3000 based on the conversion rule which is described in the first example embodiment.

For example, it is assumed that the measurement signal is the electric signal which indicates the voltage of the battery cell group 3040 using the magnitude of the amplitude. In this case, a conversion rule, which is used to associate the statistic value acquired from the amplitude of the measurement signal with the voltage of the battery cell group 3040, is defined in advance. The state information generation unit 3100 converts the statistic value acquired from the amplitude of the measurement signal that is output from the measurement device 3060 into the voltage of the battery cell group 3040 using the conversion rule. Furthermore, the state information generation unit 3100 generates the state information which is acquired in the conversion and which indicates the voltage of the battery cell group 3040. The state information generation unit 3100 generates the state information in the same manner for a case where the measurement signal indicates the current that flows into the battery cell group 3040 and the temperature of the battery pack 3000.

<Method for Controlling Switch 2080>

As the same with the control unit 2120 according to the first example embodiment, the control unit 2120 according to the second example embodiment controls the switch 2080 according to a result of determination of 1) whether or not the battery cell group 3040 is in the overvoltage state, 2) whether or not the battery cell group 3040 is in the deep discharge state, 3) whether or not the battery cell group 3040 is in the overcurrent state, 4) whether or not the battery pack 3000 is in the temperature abnormality state, or 5) whether or not the cell balance abnormality occurs in the battery cell group 3040.

It is assumed that the switch 2080 is controlled according to whether or not the battery cell group 3040 is in the overvoltage state. In this case, for example, the state information generation unit 3100 generates the state information which indicates the voltage of the battery cell group 3040. In a case where the voltage of the battery cell group 3040 is equal to or higher than the threshold, the control unit 2120 opens the switch 2080.

Here, timing at which the measurement device 3060 measures the voltage of the battery cell group 3040 is arbitrary. For example, in a case where the state information generation unit 3100 generates the state information, the measurement device 3060 measures the voltage of the battery cell group 3040. In another example, the measurement device 3060 periodically measures the voltage of the battery cell group 3040, and put the result of the measurement into a storage device included in the battery pack 3000. In the latter case, the state information generation unit 3100 reads the voltage of the battery cell group 3040 from the storage device, and puts the read value into the state information.

It is assumed that the switch 2080 is controlled according to whether or not the battery cell group 3040 is in the deep discharge state. In this case, the state information generation unit 3100 also generates the state information which indicates the voltage of the battery cell group 3040. In a case where the voltage of the battery cell group 3040 is equal to or lower than the threshold, the control unit 2120 opens the switch 2080.

It is assumed that the switch 2080 is controlled according to whether the battery cell group 3040 is in the overcurrent state. In this case, the state information generation unit 3100 generates the state information which indicates the current that flows into the battery cell group 3040. In a case where the current that flows into the battery cell group 3040 is equal to or larger than the threshold, the control unit 2120 opens the switch 2080. Note that, as the same with the timing at which the measurement device 3060 measures the voltage of the battery cell group 3040, timing at which the measurement device 3060 measures the current that flows into the battery cell group 3040 is arbitrary.

It is assumed that the switch 2080 is controlled according to whether or not the battery pack 3000 is in the temperature abnormality state. In this case, the state information generation unit 3100 generates the state information which indicates the temperature of the battery pack 3000. In a case where the temperature of the battery pack 3000 is equal to or higher than the threshold, the control unit 2120 opens the switch 2080.

The switch 2080 is controlled according to whether or not the cell balance abnormality occurs in the battery cell group 3040. In this case, the state information generation unit 3100 generates the state information which indicates the respective voltages of the plurality of battery cells 3042 that are included in the battery cell group 3040. In a case where the variation on the voltages of the plurality of battery cells 3042 is large, the control unit 2120 opens the switch 2080.

<Control Considering History of Battery Pack 3000>

The protection apparatus 2000 according to the example embodiment may take various histories for the battery pack 3000 into consideration as the state of the battery pack 3000. For example, in a case where a maximum charging number is defined for the battery cell group 3040, charging should not be performed when the number of times thereof exceeds the maximum charging number.

In this case, the battery pack 3000 puts the number of times (hereinafter, a charging cycle number) that the battery cell group 3040 is charged so far into a storage device. The state information generation unit 3100 puts the charging cycle number into the state information. In a case where the charging cycle number indicated by the acquired state information is larger than the threshold (the maximum charging number), the control unit 2120 the opens the switch 2080. On the other hand, in a case where the charging cycle number indicated by the acquired state information is equal to or less than the threshold, the control unit 2120 closes the switch 2080.

In another example, a history for the battery pack 3000 includes a history of charging and discharging of the battery pack 3000. The history of the charging and discharging of the battery pack 3000 includes, for example, a history of the voltage of the battery cell group 3040, a history of the current that flows into the battery cell group 3040, a history of the temperature of the battery pack 3000, and the like.

In this case, the battery pack 3000 puts the history of the charging and discharging of the battery pack 3000 into a storage device. The state information generation unit 3100 puts the history of the charging and discharging into the state information. In a case where the history of the charging and discharging of the battery pack 3000 indicated by the acquired state information indicates an abnormal history, the control unit 2120 opens the switch 2080. On the other hand, in a case where the history of the charging and discharging of the battery pack 3000 indicated by the acquired state information indicates a normal history, the control unit 2120 closes the switch 2080. Here, it is possible to use an existing technology as a technology for determining whether or not the history of the voltage, the current, the temperature, or the like of the battery pack 3000 is abnormal.

As described above, in a case where the charging of the battery pack 3000 is controlled by taking the history relevant to the battery pack 3000 into consideration, it is possible to more safely charge the battery pack 3000.

<Method for Identifying Battery Pack 3000>

As described in the first example embodiment, it is preferable that the protection apparatus 2000 identifies the type of the battery pack 3000 and performs control according to the identified type of the battery pack 3000. For example, the protection apparatus 2000 according to the second example embodiment controls the switch 2080 based on the current which flows through the resistive element 3160 using the same method as in the protection apparatus 2000 according to the first example embodiment.

In another example, in the charging system 100 according to the second example embodiment, the state information, which is provided from the state information generation unit 3100, may include an identifier (hereinafter, a type identifier) which indicates the type of the battery pack 3000. In this case, the state information generation unit 3100 generates the state information which includes the type identifier of the battery pack 3000. The type identifier of the battery pack 3000 is stored, for example, in a storage device included in the battery pack 3000 in advance.

The control unit 2120 controls the switch 2080 using the type identifier included in the state information. For example, the conversion rule, which is used to convert the measurement signal into the physical quantity relevant to the battery pack 3000, is stored in the storage device 5080 or the like in association with each type identifier of the battery pack 3000. In this case, the control unit 2120 acquires the conversion rule corresponding to the type identifier included in the state information, and controls the switch 2080 using the conversion rule.

In another example, the above-described various thresholds are stored in the storage device 5080 or the like in association with each type identifier of the battery pack 3000. In this case, the control unit 2120 acquires the threshold corresponding to the type identifier included in the state information, and controls the switch 2080 using the threshold.

Note that, the control unit 2120 may acquire the above-described conversion rule or the threshold using the identifier of the battery cell group 3040 or the identifier of each battery cell 3042. In this case, the conversion rule or the threshold is associated with the identifier of the battery cell group 3040 or the identifier of the battery cell 3042.

<Example of Hardware Configuration>

The state information generation unit 3100 may be realized by hardware (for example: a hard-wired electronic circuit or the like) or may be realized by a combination (for example: a combination of an electronic circuit and a program which controls the electronic circuit, or the like) of hardware and software. In a case where the state information generation unit 3100 is realized by the combination of the hardware and the software, the state information generation unit 3100 is realized using the same computer as in the computer 5000 (refer to FIG. 2) which realizes the control unit 2120.

Here, there is a case where a computer, which is used to control the battery pack, is built in the battery pack. The computer is referred to as a Battery Management System (BMS) or the like. Here, the state information generation unit 3100 may be realized as a function of the BMS.

Note that, in order to prevent a waste of electricity due to the battery pack 3000, it is preferable that the computer, which realizes the state information generation unit 3100, is driven only in a case where the battery pack 3000 is used. For example, a power supply switch is provided in the battery pack 3000, and the computer is driven only in a case where the power supply switch is in an ON state.

<Detailed Example of Flow of Process Performed by Charge System 100>

Here, a series of flows of a process performed in the charging system 100 according to the second example embodiment will be described with a detailed example The flow which will be described below is only an example

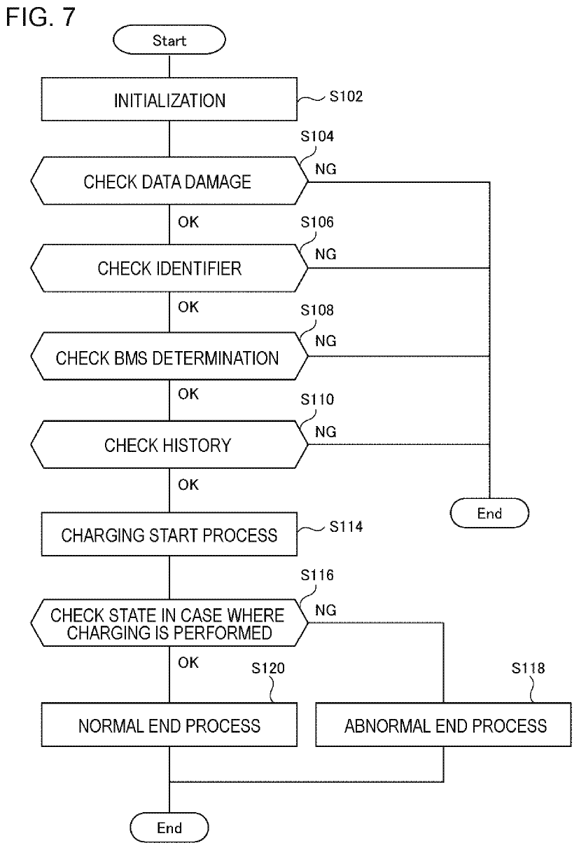

FIG. 7 is a flowchart illustrating the flows of the process which is performed in the charging system 100. First, various types of initialization are performed on the charging system 100 (S102). For example, in the protection apparatus 2000, the control unit 2120 opens the switch 2080. In addition, the state information generation unit 3100 generates and transmits the state information. In the state information which is generated here includes the type identifier of the battery pack 3000 and various histories (the charging cycle number, the history of the charging and discharging, and the history of the temperature) relevant to the battery pack 3000.

The control unit 2120 checks whether or not the acquired state information is damaged (S104). In a case where the state information is damaged (S104: NG), the process in FIG. 7 ends.

In a case where the state information is not damaged (S104: OK), the control unit 2120 checks the type identifier of the battery pack 3000 (S106). In a case where the identifier is checked, it is possible to prevent the battery pack which cannot be treated by the control unit 2120 (for example, a non-regular battery pack) from being incorrectly used as the charging target.

For example, a list of type identifiers of battery packs 3000 acceptable to the control unit 2120 is stored in a storage device in advance. Furthermore, the control unit 2120 determines whether or not the type identifier indicated by the state information is included in the list. In a case where the type identifier is not included in the list, a result of identifier check is NG. In a case where the result of the identifier check is NG (S106: NG), the process in FIG. 7 ends.

On the other hand, in a case where the type identifier is included in the list, the result of the identifier check is OK. In a case where the result of the identifier check is OK (S106: OK), the control unit 2120 checks whether or not abnormality exists in the BMS (S108). The check performed in S108 includes, for example, 1) a check of whether or not a reference voltage, which is generated from a power supply circuit block in the BMS, is a normal value, 2) a check of whether or not an analog measurement element (a multiplexer circuit or the like) of the measurement device 3060 is normally operated, or 3) a check of whether or not an element which converts an analog measurement value into a digital value (an A/D converter circuit or the like) in the measurement device 3060 is normally operated.

In a case where the BMS determination check is OK (S108: OK), the control unit 2120 performs a history check (S110). Specifically, 1) a check of the charging cycle number, 2) a check of the history of the voltage of the battery cell group 3040, 3) a check of the history of the current that flows into the battery cell group 3040, and 4) a check of the history of the temperature of the battery pack 3000 are performed. In a case where the charging cycle number is larger than the maximum charging number, a result of the history check is NG. In addition, in a case where any of the history of the voltage of the battery cell group 3040, the history of the current that flows into the battery cell group 3040, and the history of the temperature of the battery pack 3000 indicates the abnormal history, the result of the history check is NG. In a case where the result of the history check is NG (S110: NG), the process in FIG. 7 ends.

On the other hand, in a case where the charging cycle number is equal to or less than the maximum charging number and all of the history of the voltage of the battery cell group 3040, the history of the current that flows into the battery cell group 3040, and the history of the temperature of the battery pack 3000 indicate a normal history, the result of the history check is OK. In a case where the result of the history check is OK (S110: OK), the control unit 2120 starts the charging of the battery pack 3000 (S114). Specifically, the control unit 2120 supplies the charging current supplied from the charging apparatus 1000 to the battery pack 3000 by closing the switch 2080.

While the battery pack 3000 is being charged, the control unit 2120 repeatedly checks the state of the battery pack 3000 (S116). Therefore, the state information generation unit 3100 periodically generates the state information and provides the state information to the control unit 2120. The state information includes the voltage of the battery cell group 3040, the current that flows into the battery cell group 3040, the temperature of the battery pack 3000, and the like.

The control unit 2120 determines the various states of the battery pack 3000 in response to the acquisition of the state information. Furthermore, in a case where it is determined that the battery pack 3000 is in an abnormal state (S116: NG), the control unit 2120 opens the switch 2080 and ends the charging of the battery pack 3000 (S118).

In a case where the charging of the battery pack 3000 is completed while the state of the battery pack 3000 is not the abnormal state, the control unit 2120 opens the switch 2080 and ends the charging of the battery pack 3000 (S120).

Note that, it is preferable that the above-described various check results are notified to the user using the display device 210 or the like which is described in the first example embodiment.

<Advantageous Effect>

In the charging system 100 of the example embodiment, a charging control mechanism is realized in a housing which is different from either the charging apparatus 1000 or the battery pack 3000, as the same with the charging system 100 of the first example embodiment. Accordingly, compared to a case where the charging control mechanism is provided in the battery pack 3000, it facilitates the miniaturization and weight reduction of the battery pack 3000.

Furthermore, in the charging system 100 of the example embodiment, the digital data (state information) which indicates the physical quantity relevant to the battery pack 3000 is generated from the result of the measurement of the measurement device 3060 in the battery pack 3000. Furthermore, the digital data is provided to the protection apparatus 2000. Generally, the digital data has a higher noise tolerance than analog data (for example, the measurement signal or the like). Therefore, according to the charging system 100 of the example embodiment, it is possible to accurately deliver the physical quantity, which is an index that indicates the state of the battery pack 3000, to the protection apparatus 2000. Accordingly, it is possible to control the charging in the charging system 100 with higher accuracy.

### Third Example Embodiment

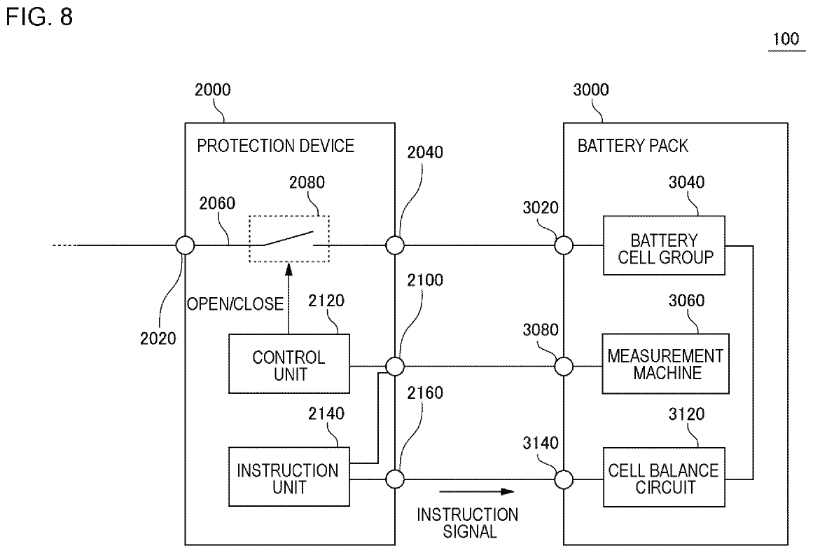

FIG. 8 is a block diagram illustrating a charging system 100 according to a third example embodiment. In FIG. 8, the charging apparatus 1000 is not illustrated. The charging system 100 of the third example embodiment has the same function as the charging system 100 of the first example embodiment or the charging system 100 of the second example embodiment other than matters which will be described later.

A battery pack 3000 of the third example embodiment includes a cell balance circuit 3120. The cell balance circuit 3120 is a circuit which is used to correct voltage balances (cell balances) of the plurality of battery cells 3042 which are included in the battery cell group 3040. It is possible to use an existing technology for a technology itself for correcting the cell balances of the plurality of battery cells.

A protection apparatus 2000 of the third example embodiment includes an instruction unit 2140. The instruction unit 2140 determines whether or not the cell balance abnormality occurs in the battery cell group 3040. In the case where the cell balance abnormality occurs in the battery cell group 3040, the instruction unit 2140 transmits a signal (hereinafter, an instruction signal) which is used to instruct the cell balance circuit 3120 to perform a process for correcting the cell balance of the battery cell group 3040 through a second communication terminal 2160.

The cell balance circuit 3120 receives an instruction signal through a second communication terminal 3140. Furthermore, the cell balance circuit 3120 corrects the cell balance of the battery cell group 3040 in response to the reception of the instruction signal.

For example, the instruction signal is a pulse wave whose amplitude changes from low to high. In this case, the cell balance circuit 3120 corrects the cell balance of the battery cell group 3040 in response to receiving the pulse wave whose amplitude changes from low to high.

Note that, in a case where the computer (for example, the BMS) which is used to control the battery pack 3000 is provided in the battery pack 3000, the instruction signal may be input to the computer. In this case, the computer which has received the instruction signal controls the cell balance circuit 3120, thereby causing the cell balance circuit 3120 to correct the cell balance of the battery cell group 3040.

A method for determining whether or not the cell balance abnormality occurs in the battery cell group 3040 is the same as the method for determining the cell balance abnormality by the control unit 2120 of the first example embodiment or the control unit 2120 of the second example embodiment. In a case where the measurement signal is provided to the protection apparatus 2000 as in the first example embodiment, the instruction unit 2140 determines whether or not the cell balance abnormality occurs in the battery cell group 3040 using the measurement signal. On the other hand, in a case where the state information is provided to the protection apparatus 2000 as in the second example embodiment, the instruction unit 2140 determines whether or not the cell balance abnormality occurs in the battery cell group 3040 using the state information.

In addition, the instruction unit 2140 may transmit the instruction signal based on the result of the determination by the control unit 2120. In this case, the control unit 2120 determines whether or not the cell balance abnormality occurs in the battery cell group 3040. In a case where it is determined that the cell balance abnormality occurs, the control unit 2120 provides a notification of the occurrence of the cell balance abnormality in the battery cell group 3040 to the instruction unit 2140. The instruction unit 2140 transmits the instruction signal in response to the reception of the notification.

<Process Performed after Correction of Cell Balance is Completed>

The control unit 2120 may have a function of recognizing that correction of the cell balance is completed by the cell balance circuit 3120. In this case, the control unit 2120 closes the switch 2080 in response to the completion of correcting the cell balance. In this manner, it is possible to cause the charging of the battery pack 3000 to be not performed while the cell balance abnormality occurs in the battery cell group 3040, and to cause the charging of the battery pack 3000 to be performed in a case where the cell balance becomes normal in the battery cell group 3040. According to such control, the convenience of the charging system 100 is improved, compared to a case where the charging of the battery pack 3000 is terminated in the case where the cell balance abnormality occurs in the battery cell group 3040.

There are various methods for the control unit 2120 to recognize the completion of the correction of the cell balance which is performed by the cell balance circuit 3120. For example, in a case where the state information is provided from the battery pack 3000 as in the second example embodiment, the information which indicates the completion of the correction of the cell balance may be included in the state information. In this case, in response to the completion of the operation of the cell balance circuit 3120, the state information generation unit 3100 generates the state information which indicates the completion of the correction of the cell balance. Furthermore, the state information generation unit 3100 transmits the state information to the protection apparatus 2000.

In another example, an interconnect used to transmit a signal which indicates the completion of the correction of the cell balance may be provided between the protection apparatus 2000 and the battery pack 3000. In this case, in a case where the correction of the cell balance is completed, the cell balance circuit 3120 transmits a pre-determined signal to the protection apparatus 2000 through the interconnect.

In another example, the control unit 2120 may repeatedly determine whether or not abnormality exists in the cell balance of the battery pack 3000. In this case, while it is determined that “abnormality exists in the cell balance of the battery pack 3000”, the control unit 2120 keeps the switch 2080 open. Furthermore, in a case where the control unit 2120 determines that “abnormality does not exist in the cell balance of the battery pack 3000”, the control unit 2120 closes the switch 2080.

<Hardware Configuration>

In the charging system 100 of the third example embodiment, a program module which is used to realize the instruction unit 2140 is included in the storage device 5080 of the computer 5000 in addition to a program which is used to realize the control unit 2120.

Hereinabove, although the example embodiments of the present invention are described with reference to the accompanying drawings, the example embodiments are examples of the present invention, and it is possible to use various configurations in addition thereto.

This application claims priority is based on and claims priority from Japanese Patent Application No. 2017-030990 filed Feb. 22, 2017, and the content of the application is incorporated herein by reference in their entirety.

1. A charging system comprising:
a battery pack; and
a protection apparatus,
wherein the battery pack includes:
a battery cell;
a measurement device that measures a physical quantity which indicates a state of the battery pack;
an input terminal to which a charging current is supplied from the protection apparatus;
a state information generation unit that generates state information which indicates the measured physical quantity; and
a communication terminal through which the state information is output to the protection apparatus, and
wherein the protection apparatus includes:
an output terminal that is connected to the input terminal of the battery pack, and that supplies the charging current from a power supply to the battery pack;
a communication terminal to which the state information is input, the state information being output from the battery pack;
an input terminal to which the charging current is supplied from the power supply;
an interconnect that connects between the input terminal and the output terminal of the protection apparatus;
a switch that is provided on the interconnect; and
a control unit that performs opening and closing of the switch based on the measured physical quantity indicated by the state information, and
wherein the battery pack and the protection apparatus are provided in housings which are different from each other.

2. The charging system according to claim 1,
wherein the physical quantity indicated by the state information is any one or more of a voltage of the battery cell, a current which flows into the battery cell, and a temperature of the battery pack.

3. The charging system according to claim 1,
wherein the control unit determines any one or more of whether or not the battery pack is in an overvoltage state, whether or not the battery pack is in a deep discharge state, whether or not the battery pack is in an overcurrent state, whether or not cell balance abnormality occurs in the battery pack, and whether or not a temperature abnormality occurs in the battery pack based on the measured physical quantity indicated by the state information, and performs opening and closing of the switch based on a result of the determination.

4. The charging system according to claim 1,
wherein the state information further includes information relevant to a history of charging in the battery pack, and
wherein the control unit determines whether or not abnormality exists in the history of the charging in the battery pack, and opens the switch in a case where the abnormality exists in the history of the charging in the battery pack.

5. The charging system according to claim 1,
wherein the battery pack includes a cell balance circuit that corrects a cell balance between a plurality of the battery cells, and
wherein the protection apparatus includes an instruction unit that determines whether or not cell balance abnormality occurs in the battery pack using the state information, and that transmits a signal which is used to cause the cell balance circuit provided in the battery pack to operate in a case where the cell balance abnormality occurs.

6. The charging system according to claim 5,
wherein the control unit closes the switch in a case where the cell balance in the battery pack is normal after the instruction unit operates.

7. A battery pack included in the charging system according to claim 1.

8. A protection apparatus included in the charging system according to claim 1.

9. A battery pack comprising:
a battery cell;
a measurement device that measures a physical quantity which indicates a state of the battery pack;
an input terminal to which a charging current is supplied from a protection apparatus which controls charging of the battery pack;
a state information generation unit that generates state information which indicates the measured physical quantity;
a communication terminal through which the state information is output to the protection apparatus; and
an interconnect that connects the input terminal and the battery cell,
wherein the charging current is supplied to the battery cell through the interconnect, the charging current being supplied from the input terminal, and
wherein a switch that blocks connection between the input terminal and the battery cell is not provided on the interconnect.
